(19) United States
(12) Patent Application Publication
(10) Pub. No.: US 2016/0312989 A1
(43) Pub. Date: Oct. 27, 2016

(54) Optical Tilt Mechanism For Wall Mount Light

(71) Applicant: Greenstar Products, Inc., San Antonio, TX (US)

(72) Inventors: Sumit Kumar Tiwary, Gurgaon (IN); Ganesh Padmaraja, Gurgaon (IN)

(73) Assignee: Greenstar Products, Inc., San Antonio, TX (US)

(21) Appl. No.: 14/994,193

(22) Filed: Jan. 13, 2016

(30) Foreign Application Priority Data
Apr. 24, 2015 (IN) 1147/DEL/2015

(51) Int. Cl. F21V 21/30; F21S 8/00

(52) U.S. Cl. CPC F21V 21/30; F21S 8/033; F21Y 2105/00

(57) ABSTRACT

A light assembly according to an embodiment has a body with an inside volume. A light panel is rotatably supported in the inside volume such that the light panel is configured to tilt about an axis A. The light assembly further includes a thread rod rotatably coupled to the body such that the thread rod is configured to rotate about an axis B different from the axis A. The light assembly also includes a direction converter engaged with the thread rod at a first end and the light panel at a second end such that the direction converter is configured to translate a rotational movement of the thread rod about the axis B to a tilting movement of the light panel about the axis A.

### CROSS-REFERENCE TO RELATED APPLICATIONS

This application is based upon and claims the benefit of priorities from Indian Patent Application No. 1147/DEL/2015 filed on Apr. 24, 2015; the entire contents of which are incorporated herein by reference.

### FIELD

Embodiments described herein relate generally to a light assembly adapted to be mounted to a wall surface, and more particularly relate to a tilt mechanism for a wall mounted light assembly.

### BACKGROUND

Wall mounted lights are designed to be secured on a wall surface to illuminate a target area, preferably with relatively uniform illumination across that area. Generally such mounted lights include one or more light panels on which a plurality of LEDs is mounted. Such lights are typically employed in the inside of a factory or a warehouse, an indoor parking space or the like to provide illumination for convenience and safety.

Since the wall mounted lights are required to illuminate downward from an upper place, the tilt angle of the light panel needs to be set in accurately before securing on the wall surface. However sometimes, the tilt angle setting beforehand may not be correct enough to focus on the target object/area. Usually the tilt angle needs further adjustment to illuminate the target object/area accurately. In that case, the wall mounted lights are required to be removed from the wall surface to re-adjust the tilt angle. Also many of the times it may happen that the target objects that are to be illuminated are moved in the inside area, such as for reasons of change of factory layout. Again in that case, the already secured wall mounted lights may be required to be removed for re-adjustment of tilt angle for accurate illumination demand.

As the above situations put forth, it would be an advantage over the existing art to provide a wall mounted lighting assembly with flexibility in adjusting the tilt angle of the light panel easily without removing the same from the wall surface.

### BRIEF DESCRIPTION OF THE DRAWINGS

FIG. 1 illustrates a general perspective view of a light assembly, in accordance with an embodiment of the present disclosure;

FIG. 2A illustrates a planar front view of the light assembly, in accordance with an embodiment of the present disclosure;

FIG. 2B illustrates a planar side view of the light assembly, in accordance with an embodiment of the present disclosure;

FIG. 2C illustrates a planar top view of the light assembly, in accordance with an embodiment of the present disclosure;

FIG. 2D illustrates a planar bottom view of the light assembly, in accordance with an embodiment of the present disclosure;

FIG. 3 illustrates a general perspective view of a body of the light assembly, in accordance with an embodiment of the present disclosure;

FIG. 4 illustrates a general perspective view of the light panel, in accordance with an embodiment of the present disclosure;

FIG. 5 illustrates a planar schematic view of a guide groove in the light panel, in accordance with an embodiment of the present disclosure;

FIG. 6 illustrates a general perspective view of a tilt mechanism of the light assembly, in accordance with an embodiment of the present disclosure;

FIG. 7 illustrates a general perspective view of a direction converter of the light assembly, in accordance with an embodiment of the present disclosure;

FIGS. 8A, 8B, 8C illustrate an sectional perspective view of the light assembly with the light panels disposed at exemplary tilt angles, in accordance with an embodiment of the present disclosure;

FIGS. 9A, 9B illustrate a comparative perspective view of the light assembly with the light panels disposed at exemplary tilt angles, in accordance with an embodiment of the present disclosure;

FIGS. 10A-1, 10A-2 illustrate a comparative front view of the light assembly with the light panels disposed at exemplary tilt angles, in accordance with an embodiment of the present disclosure;

FIGS. 10B-1, 10B-2 illustrate a comparative bottom view of the light assembly with the light panels disposed at exemplary tilt angles, in accordance with an embodiment of the present disclosure; and

FIGS. 10C-1, 10C-2 illustrate a comparative side view of the light assembly with the light panels disposed at exemplary tilt angles, in accordance with an embodiment of the present disclosure.

### DETAILED DESCRIPTION

In one aspect, the present disclosure provides a light assembly. The light assembly includes a body having an inside volume. A light panel is rotatably supported in the inside volume such that the light panel is configured to tilt about an axis A. The light assembly further includes a thread rod rotatably coupled to the body such that the thread rod is configured to rotate about an axis B different from the axis A. The light assembly also includes a direction converter engaged with the thread rod at a first end and the light panel at a second end such that the direction converter is configured to translate a rotational movement of the thread rod about the axis B to a tilting movement of the light panel about the axis A.

In other aspect, the present disclosure provides a tilt mechanism for a light panel in a light assembly in which the light panel includes a guide groove and adapted to tilt about an axis A in the light assembly. The tilt mechanism includes a thread rod configured to rotate about an axis B different from the axis A. The tilt mechanism further includes a direction converter engaged with the thread rod at a first end and the guide groove at a second end such that the direction converter is configured to translate a rotational movement of the thread rod about the axis B to a tilting movement of the light panel about the axis A.

In yet another aspect, the present disclosure provides a method for providing a tilt movement to a light panel in a light assembly in which the light panel includes a guide groove and adapted to tilt about an axis A. The method includes providing a rotational movement to a thread rod about an axis B different from the axis A. The method further includes translating the rotational movement of the thread rod about the axis B to a linear movement of a direction converter along the axis B by rotatably coupling the direction converter with the thread rod. The method further includes translating the linear movement of the direction converter along the axis B to a sliding movement of a slider in a guide groove of the light panel. The method further includes translating the sliding movement of the slider in the guide groove to a tilt action of the light panel by engaging the slider into the guide groove.

Detailed embodiments of the present light assembly are disclosed herein; however, it is to be understood that disclosed embodiments are merely exemplary of the present disclosure, which may be embodied in various alternative forms. Specific structural and functional details disclosed herein are not to be interpreted as limiting, but merely as a basis for the claims and as a representative basis for teaching one skilled in the art to variously employ the present disclosure in virtually any appropriate structure.

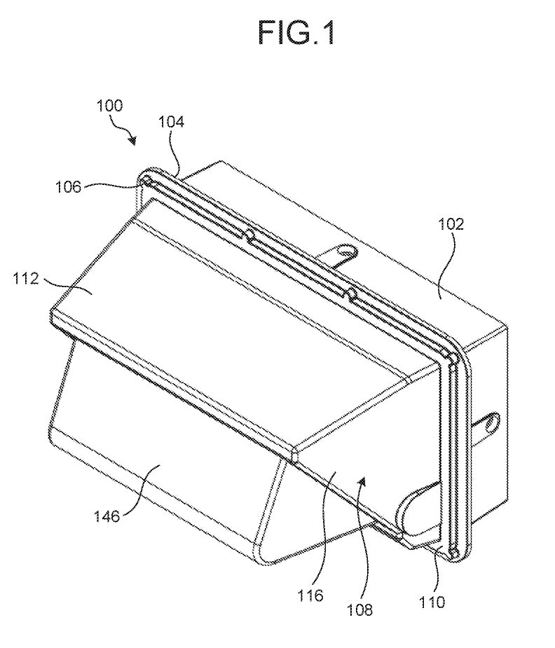

FIG. 1 illustrates a perspective view of a light assembly 100 in accordance with an embodiment of the present disclosure. Some electric devices such as control circuit and electric wirings are omitted in drawings, but conventional devices and methods may be adopted. The light assembly 100 may be typically employed to be installed in a workspace, such as a factory, a warehouse, an indoor parking, etc. The light assembly 100 of the present disclosure may be commonly installed above a target object/area to be illuminated in the workspace. In accordance with an embodiment, the light assembly 100 may be adapted to be secured on a wall surface 10.

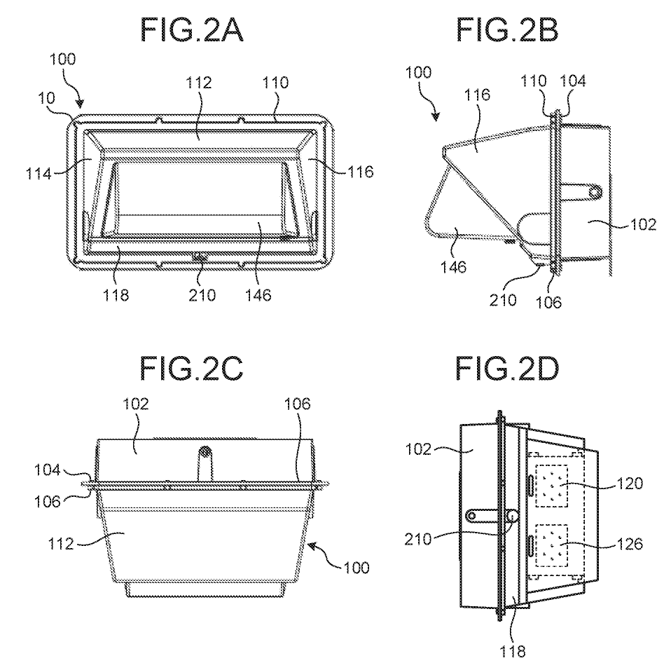

Referring to FIGS. 2 A-D, the light assembly 100 may include a back cover 102 which may be adapted to be recessed into a concave void (not shown) in the wall surface 10, The light assembly 100 may be mounted to the wall surface 10 by securing the back cover 102 to the wall surface 10 using some fastening means. In an embodiment, the back cover 102 may include a flange portion 104 adapted to rest against the wall surface 10. Further, the light assembly 100 may include fasteners 106, such as screws, to secure the flange portion 104 to the wall surface 10. The back cover 102 may be employed to house some of the electronic components including a power circuit (not illustrated) of the light assembly 100,

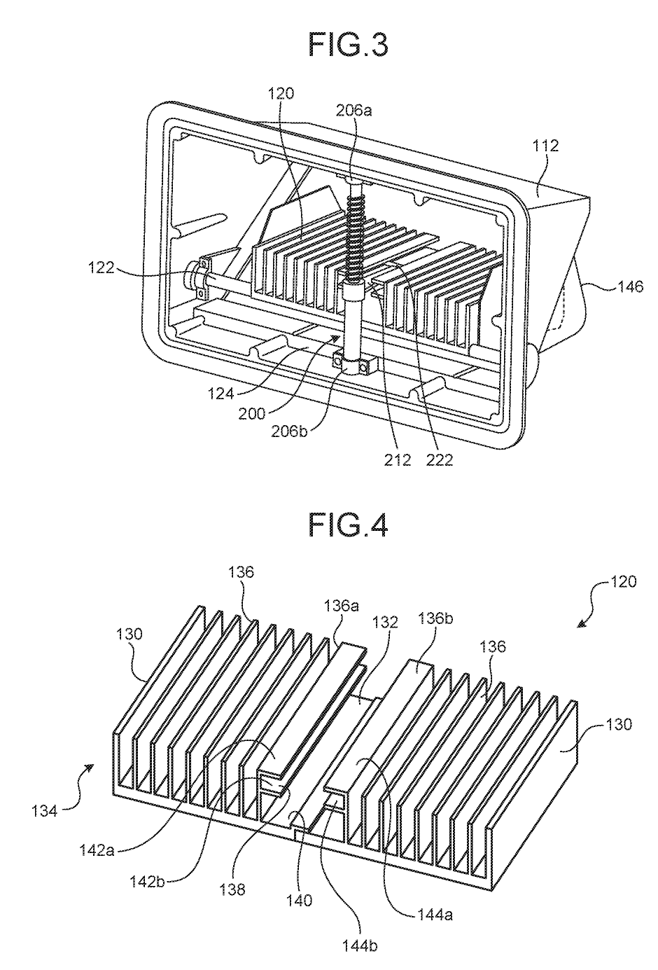

As illustrated in FIG. 3, the light assembly 100 may include a body 108. The body 108 may be fixedly connected to the back cover 102 from one of the sides (not shown). In an embodiment, the body 108 may also include a flange portion 110 adapted to be fixedly secured with the flange portion 104 of the back cover 102 and thereby secured to the wall surface 10. It may be contemplated by a person skilled in the art that the same fasteners 106 may be employed for securing both the body 108 as well as the back cover 102 to the wall surface 10. In particular, the body 108 may include an upper side 112 which may be extending in a direction perpendicular to the wallsurface 10. In an embodiment, as illustrated more clearly in FIG. 2B, the upper side 112 may be extending perpendicularly to some extent and therefrom extend in an angular fashion. The body 108 may further include two lateral sides 114, 116 extending downwardly from the upper side 112, more clearly illustrated in FIG. 2A. As in the illustrated embodiment, the lateral sides 114, 116 may be defined as substantially triangle-shaped. Further in an embodiment, the body 108 may include a lower side 118 which defines its enclosed structure. The body 108 may be construed to be substantially in the shape of an extruded triangle, with one side removed and defining a hollow inside volume.

The light assembly 100 of the present disclosure may further include a light panel 120. The light panel 120 may be disposed in the inside volume of the body 108. The light assembly 100 may include a rod 122 supported between the two lateral sides 114, 116 of the body 108. It may be contemplated that the rod 122 may be supported by some fastening means known in the art. In one embodiment, as illustrated in FIG. 3, the light panel 120 may be rotatably supported on the rod 122 adjacent to one of its edge 124. In an alternate embodiment, the light panel 120 may be rotatably coupled to the rod 122 adjacent to the edge 124. For this purpose the rod 122 may be supported between the two lateral sides 114, 116 by some rotatable joints. In the light assembly 100, an axis A is defined along the longitudinal direction of the rod 122. The light panel 120 may be adapted to rotate along the rotational axis A in order to adjust a tilt angle θ with respect to the body 108.

Referring back to FIG. 1, the light panel 120 may include a light source 126 disposed thereon. The light source 126, for example, may include a plurality of LEDs (Light Emitting Diodes) mounted on the light panel 120. The light panel 120 may include a first surface 128 which may be in the form of a substrate with the required electrical connections, on to which the plurality of LEDs is mounted. Further the light panel 120 may be connected to the power circuit, as mentioned earlier, to provide the electric power for the light source 126 to illuminate.

In an exemplary embodiment of the present disclosure, when the light panel 120 is angled such that θ is close to 0 degree, the light source 126 may be adapted to illuminate downside, along with the wall surface 10. In other example, when the light panel 120 is angled such that θ is close to 50 degrees, the light source 126 may be adapted to illuminate in a down-front direction. It may be contemplated by a person skilled in the art that the tilt angle θ may be set based on the purpose and position of the target object/area to be illuminated.

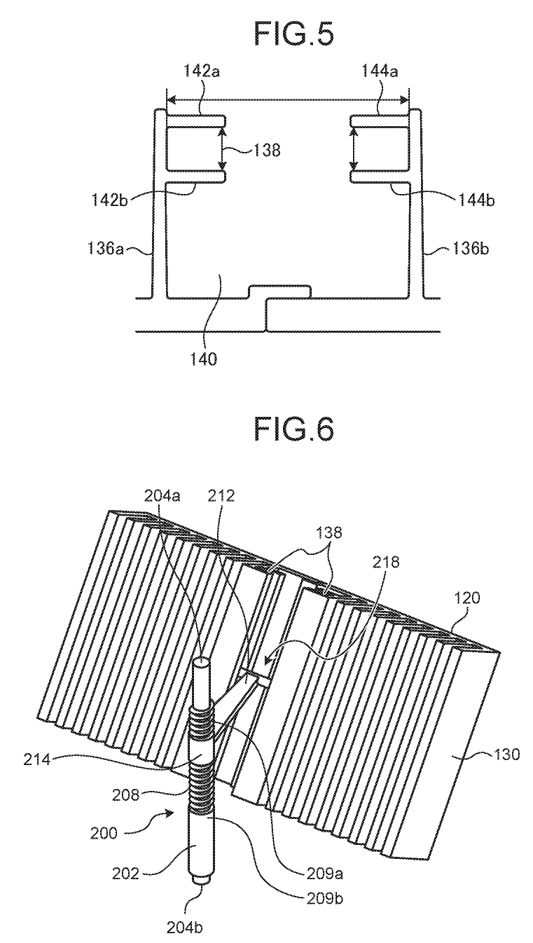

FIG. 4 illustrates a detailed back view of the light panel 120 in accordance with an embodiment of the present disclosure. The light panel 120 may include lateral end surfaces 130 disposed opposite to each other and may be made of insulating material. The light panel 120 may further include a second surface 132 stretching between the two end surfaces 130. In an embodiment, the light panel 120 may include a heat sink assembly 134 disposed on the second surface 132. The heat sink assembly 134 may be thermally connected to the light panel 120, and configured to dissipate heat generated by the light source 126 mounted on the first surface 128 thereof. Further, as illustrated, the heat sink assembly 134 may include a plurality of fins 136 in the form of planar sheets extending orthogonally from the second surface 132. The fins 136 may be made of materials with higher heat transfer efficiency such as, but not limited to, aluminium. The fins 136 may be adapted to increase the heat dissipation performance of the heat sink assembly 134.

Further, as illustrated in FIG. 4, the light panel 120 may include a guide groove 138 defined towards the second surface 132. FIG. 5 provides a sectional schematic view of the guide groove 138. The guide groove 138 may be located about the central portion 140 of the second surface 132. From the illustration, it may be understood by a person skilled in the art that the guide groove 138 may be defined by four planar panes 142a, 142b and 144a, 144b, where two panes each may be extruding from each of two fins 136a, 136b. It may be contemplated that the two fins 136a, 136b may be located on opposite sides from the central portion 140, and further the planar panes 142a, 142b and 144a, 144b may be extending parallel to the second surface 132 and in the opposite direction.

Referring back to FIG. 1, the light assembly 100 may also include a front cover 146. According to an embodiment, the front cover 146 may be made of a substantially transparent material, such as, but no limited to, glass, plastic or other transparent materials in order to allow emitted light from the light panel 120 to pass through. As in the illustrated embodiment, the front cover 146 may be defined substantially in the shape of an extruded triangle with one side removed and with a hollow inside volume. However, it may be understood that the front cover 146 may be in any other shape such that, when connected to the body 108, it may not interfere with a tilt action of the light panel 120 disposed therein.

The front cover 146 may be adapted to be connected with the body 108 in a manner as illustrated. The front cover 146 may be so arranged that the light panel 120 may be allowed to rotate inside the front cover 146 smoothly without any collision with the other parts. The front cover 146 may be designed to complement the shape of the body 108 substantially like a cover for a box. The front cover 146 may have a slightly smaller opened area in comparison to opened area of the body 108, and is adapted such that the opened area of the front cover 146 may be seated into the opened area of the body 108. Further the front cover 146 may be rigidly connected to the body 108 by means known in the art, such as, but not limited to, fasteners. The body 108 along with the front cover 146 may be construed to be in the form of a shell adapted to protect the components, such as the light panel 120, installed in the inside volume of the light assembly 100.

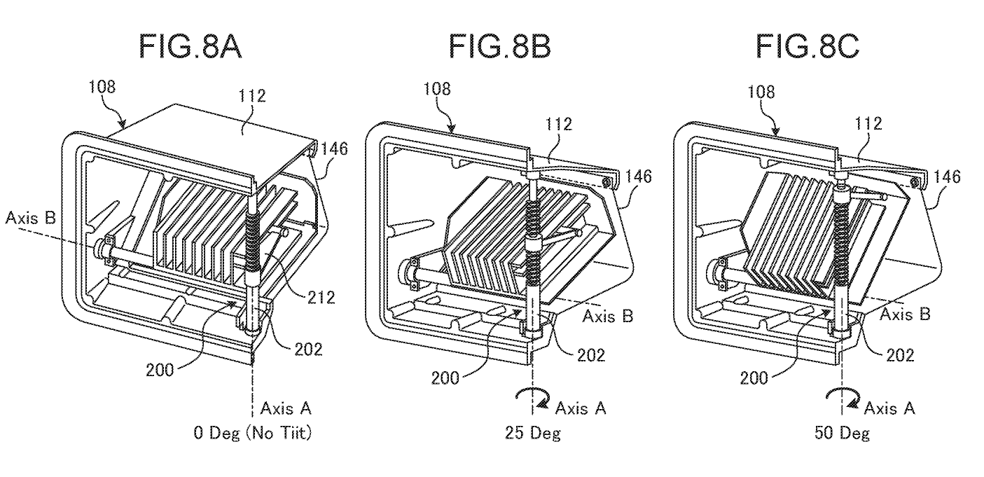

Now referring to FIG. 6, the light assembly 100 may include a tilt mechanism 200 in accordance with an embodiment of the present disclosure. The tilt mechanism 200 may be configured to adjust the tilt angle θ of the light panel 118 installed inside the body 108. According to an exemplary embodiment, further illustrated in FIG. 8A-C, the tilt mechanism 200 of the present disclosure may be configured to set/adjust the tilt angle θ of the light panel 120 in the range between 0 to 50 degrees. However it may be understood that the present tilt mechanism 200 may not be restricted to this exemplary range and may be adapted to even beyond the said range. The tilt mechanism 200 may include a thread rod 202 having two ends, an upper end 204a and a lower end 204b. The two ends 204a, 204b may be coupled in connection with the body 108 by means of two rotatable joints, an upper joint 206a and a lower joint 206b. In an embodiment, the thread rod 202 may include a thread portion 208 defined along a portion of its length along an axis B. The thread portion 208 may extend between an upper point 209a and a lower point 209b.

Further, the tilt mechanism 200 may include a screw 210 formed with the thread rod 202. Specifically, the screw 210 may be formed below the lower joint 206b of the thread rod 202. The screw 210 may be disposed outside of the body 108 and/or the front cover 146 so that the screw 210 may be rotatable from downward of the light assembly 100. The screw 210 may be positioned to afford no or minimum interference to the light emission from the light panel 120. The screw 210 may be adapted to be turned both clockwise and counter-clockwise about the axis B.

It may be understood that the screw 210 may be turned by using a screwdriver or the like, by some personnel from outside of the light assembly 100. In an alternate embodiment, the light assembly 100 may include a motorized turning mechanism (not illustrated) for the screw 210. The said mechanism is regulated by a controller (not illustrated), such a two-way lever, knob or a dial with angular indentations corresponding to the tilt angle θ. The controller may be installed on the wall surface within the easy reach of the personnel.

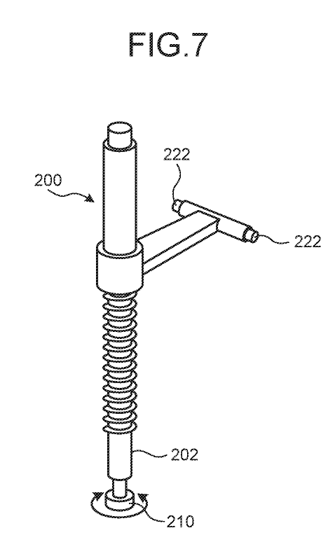

The tilt mechanism 200 may further include a direction converter 212 coupled with the thread rod 202. FIG. 7 illustrates a detailed embodiment of the direction converter 212 in a particular reference with the thread rod 202. In an embodiment, the direction converter 212 may include a ring 214, with internal threads (not shown), disposed towards a first end 216. The internal threads of the ring 214 may be engaged with the thread portion 208 of the thread rod 202. It may be understood that the ring 214 encircles a part of the thread portion 208. Further it may be understood by a person having ordinary skill in the art that such an arrangement allows for translating the rotational movement of the thread rod 202 to a linear movement (upward and downward directions) of the direction converter 212 along the axis B.

The direction converter 212 may further include a slider 218 disposed towards a second end 220. The slider 218 may be in the form of a rod connected at the second end 220 and extending orthogonally to a longitudinal axis C of the direction converter 212. As may be understood from FIG. 7, the slider 218 in conjunction with the direction converter 212 may form a substantially T-shaped structure. The slider 218 may further include protrusions 222 formed at its ends 224. In an aspect of the present disclosure, the protrusions 222 may be adapted to be engaged in the guide groove 138 of the light panel 120. It may be contemplated be a person skilled in the art that when the screw 210 is turned about the axis B, the direction converter 212 travels linearly along the axis B, forcing the slider 218 to slide in the guide groove 138 and in turn leading to the tilt action of the light panel 120 about the axis A. It may also be understood that the span of the thread rod from the axis B to the protrusions 222 remains constant during the linear movement of the direction converter 212.

Aspects, advantages and/or other features of exemplary embodiments of the disclosure will become apparent in view of the following detailed description, which discloses various non-limiting embodiments of the disclosure. It is to be understood that specific examples may include all technical equivalents that operate in a similar manner to accomplish a similar purpose. Further individual features shown or described for one embodiment may be combined with individual features shown or described for another embodiment. Also some features as shown or described in the context of functional segments may be omitted within the scope of the present disclosure.

Since the wall mounted lights are required to illuminate downward from an upper place, the tilt angle of the light panel installed therein needs be set in accurately before securing on the wall surface. However sometimes, the tilt angle setting beforehand may not be correct enough to focus on the target object/area and therefore the tilt angle may require further adjustments to illuminate the target object/area accurately. In that case, the wall mounted lights are required to be removed from the wall surface to re-adjust the tilt angle which may be a big hassle for the personnel.

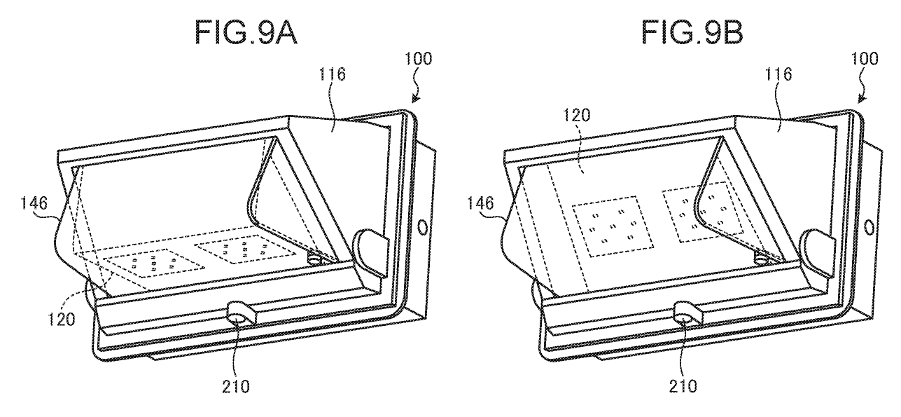

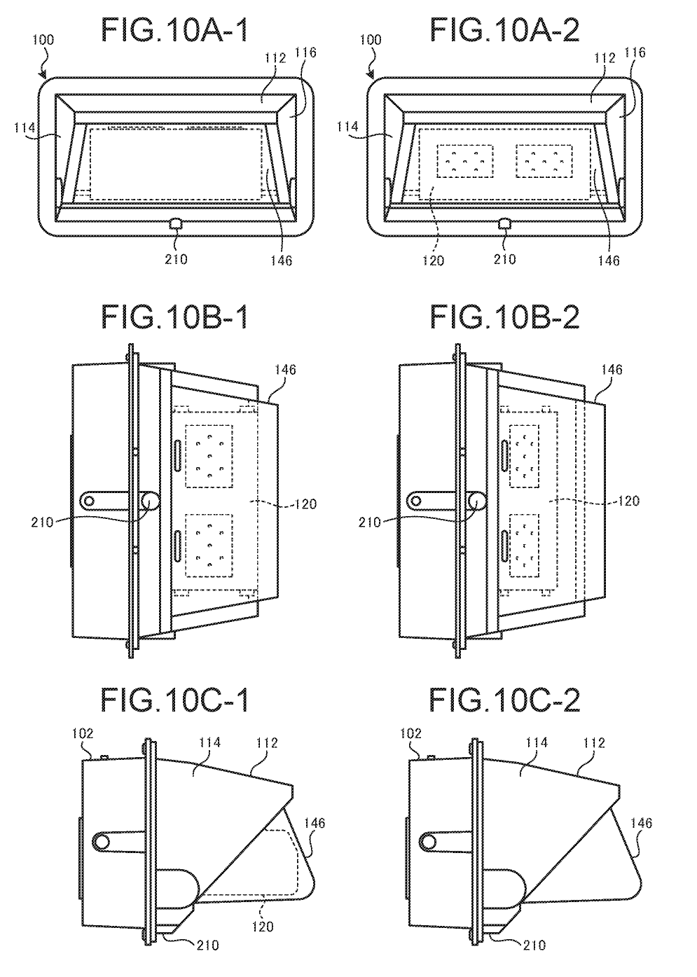

The light assembly 100 of the present disclosure is designed such that the tilt angle θ of the light panel 120 may be changed without the need of removing it from the wall surface 10. The present disclosure provides the tilt mechanism 200 for adjusting the tilt angle θ of the light panel 120 while the light assembly 100 is secured to the wall surface 10. For the purpose of present disclosure, the tilt mechanism 200 may allow adjusting the tilt angle θ of the light panel 120 in the range between 0 to 50 degrees. The tilt mechanism 200 is explained in detail below with reference to FIGS. 8 to 10C-2.

FIG. 8A illustrates a condition when the direction converter 212, or specifically the ring 214, is positioned at the lower point 209b along the thread rod 202. At this condition, the light panel 120 is disposed with the tilt angle θ close to 0 degrees resulting in the light source 126 illuminating in the downward direction along with the wall surface 10.

As explained earlier, the light assembly 100 of the present disclosure allows for turning of the screw 210 from outside by some personnel. When the screw 210 is turned in a specific rotational direction about the axis B, the thread rod 202 rotates along with the screw 210. Further the engagement of the thread portion 208 and the internal threads of the ring 214 translate this rotational motion about axis B to linear movement of direction converter 212. Depending on the handedness of the thread portion 208, the direction converter 212 may move either upwardly or downwardly along the axis B. Assuming on clockwise rotation of the screw 210, the direction converter 212 moves upwardly along the axis B.

FIG. 8B illustrates a condition when the screw 210 is turned clockwise. In response to this, the direction converter 212 starts moving upwardly which forces the slider 218 to travel in the guide groove 138 and in turn lead to tilt action of the light panel 120 about the axis A. This may be possible because the span of the thread rod 202 from the axis B to the protrusions 222 remains constant during the linear movement of the direction converter 212. As illustrated in FIG. 8B, as the direction converter 212 moves closer to the middle of the length of the thread portion 208, the light panel 120 is tilted with the tilt angle θ close to 25 degrees. In this condition, the light source 126 illuminates the area in front and at a little distance from the wall surface 10.

FIG. 8C illustrates a condition when the screw 210 is further turned in the same rotational direction. In response, the direction converter 212 moves further upward along the axis B and the slider 218 travels further in the guide groove 138. At some point, the direction converter 212 reaches the upper point 209a of thread portion 208, resulting in the light panel 120 being further tilted about the axis A with the tilt angle θ close to 50 degrees. In this arrangement, the light source 126 is adapted to illuminate further area from the wall surface 10.

It is intended that all matter contained in the above description or illustrated in the accompanying drawings shall be interpreted as illustrative only and not limiting of the scope of the disclosure. Changes in detail or structure may be made based on design demands without departing from the spirit of the present disclosure. For example, the size, shape or number of light panels 120 may be determined based on the optical design and the mounted LEDs performance. In some cases, the heat sink assembly may not be essential for the purpose of the present disclosure. It is further possible to include a screw formed at the upper end 204a in order to adjust the tilt angle θ from upwards. Further it may be appreciated that the disclosed light assembly 100 may be easily modified to be mountable on to a ceiling.

While certain exemplary embodiments have been described and shown in the accompanying drawings, it is to be understood that such embodiments are merely illustrative of and not restrictive on the broad present disclosure, and that this present disclosure is not limited to the specific constructions and arrangements shown and described, since various other modifications and/or adaptations may occur to those of ordinary skill in the art. All directional references (e.g., upper, lower, upward, downward, top, bottom, above, below, vertical, horizontal, clockwise, and counter-clockwise) are only used for identification purposes to aid the reader's understanding of the present disclosure, and hence, may not be construed to create limitations, particularly as to the position, orientation, or use of the devices and/or methods disclosed herein. Examples and limitations related therewith are intended to be illustrative and not limiting in any manner, and modifications may be made without departing from the spirit of the present disclosure as defined in the appended claims.

What is claimed is:

1. A light assembly, comprising:
a body having an inside volume;
a light panel rotatably supported in the inside volume, wherein the light panel is configured to tilt about an axis A;
a thread rod rotatably coupled to the body, wherein the thread rod is configured to rotate about an axis B different from the axis A; and
a direction converter engaged with the thread rod at a first end and the light panel at a second end, wherein the direction converter is configured to translate a rotational movement of the thread rod about the axis B to a tilting movement of the light panel about the axis A.

2. The light assembly as disclosed in claim 1 wherein the body is adapted to be secured to a wall surface.

3. The light assembly as disclosed in claim 1 wherein the light panel includes a light source disposed on a first side thereof.

4. The light assembly as disclosed in claim 1 wherein the light panel includes a guide groove disposed on a second side thereof.

5. The light assembly as disclosed in claim 1 wherein the direction converter includes a slider disposed at the second end.

6. The light assembly as disclosed in claim 4 wherein the guide groove is adapted to receive and engage with the slider, the slider being configured to travel in the guide groove.

7. The light assembly as disclosed in claim 1 wherein the direction converter further includes a ring disposed at the first end, the ring being adapted to be rotatably coupled with the thread rod.

8. The light assembly as disclosed in claim 1 further includes a screw coupled to the thread rod, the screw is adapted to be turned outside the body and in response provide a rotational movement to the thread rod.

9. A tilt mechanism for a light panel in a light assembly wherein the light panel includes a guide groove and adapted to tilt about an axis A in the light assembly, the tilt mechanism comprising:
a thread rod configured to rotate about an axis B different from the axis A; and
a direction converter engaged with the thread rod at a first end and the guide groove at a second end, wherein the direction converter is configured to translate a rotational movement of the thread rod about the axis B to a tilting movement of the light panel about the axis A.

10. The tilt mechanism as disclosed in claim 9 wherein the direction converter includes a ring disposed at the first end, the ring being adapted to be rotatably coupled with the thread rod.

11. The tilt mechanism as disclosed in claim 10 wherein the direction converter further includes a slider disposed at the second end, the slider being adapted to be engaged with the guide groove in the light panel.

12. The tilt mechanism as disclosed in claim 11, wherein the direction converter is configured to translate the rotational movement of the thread rod about the axis B to a linear movement of the ring along the axis B.

13. The tilt mechanism as disclosed in claim 12, wherein the direction converter is further configured to translate the linear movement of the ring along the axis B to a sliding movement of the slider in the guide groove leading to a tilt action of the light panel.

14. A method for providing a tilt movement to a light panel in a light assembly wherein the light panel includes a guide groove and adapted to tilt about an axis A in the light assembly, the method comprising:
providing a rotational movement to a thread rod about an axis B different from the axis A;
translating the rotational movement of the thread rod about the axis B to a linear movement of a direction converter along the axis B by rotatably coupling the direction converter with the thread rod;
translating the linear movement of the direction converter along the axis B to a sliding movement of a slider;
translating the sliding movement of the slider in a guide groove of the light panel to a tilt action of the light panel by engaging the slider into the guide groove.

15. The method as disclosed in claim 14 further including providing a turning movement to a screw about the axis B, the screw being disposed outside of a body of the light assembly.
